(19) United States
(12) Patent Application Publication
(10) Pub. No.: US 2026/0142223 A1
(43) Pub. Date: May 21, 2026

(54) ELECTROLYTE COMPOSITION FOR LITHIUM SECONDARY BATTERY AND LITHIUM SECONDARY BATTERY COMPRISING SAME

(71) Applicants: Hyundai Motor Company, Seoul (KR); Kia Corporation, Seoul (KR); UNIST (Ulsan National Insitute of Science and Technology), Ulsan (KR)

(72) Inventors: Huibeom Nam, Hwaseong (KR); Won-Jin Kwak, Ulsan (KR); Hyo-gyeong Kwon, Incheon (KR)

(21) Appl. No.: 19/239,260

(22) Filed: Jun. 16, 2025

(30) Foreign Application Priority Data
Nov. 20, 2024 (KR) 10-2024-0166125

(51) Int. Cl. H01M 10/0525; H01M 4/02; H01M 4/131; H01M 4/133; H01M 4/134; H01M 4/38; H01M 4/505; H01M 4/525; H01M 4/583; H01M 10/0568; H01M 10/0569

(52) U.S. Cl. CPC H01M 10/0525; H01M 4/131; H01M 4/133; H01M 4/134; H01M 4/386; H01M 4/505; H01M 4/525; H01M 4/583; H01M 10/0568; H01M 10/0569; H01M 2004/027; H01M 2004/028; H01M 2300/004; H01M 2300/0051

(57) ABSTRACT

Provided is an electrolyte composition for a lithium secondary battery and a lithium secondary battery comprising same. The electrolyte composition includes a non-aqueous organic solvent composed of a first and second carbonate-based solvent, where the second solvent incorporates a compound of Chemical Formula 1, and a lithium salt. By adjusting the volume ratio of these solvents and the content of the compound of Chemical Formula 1, the electrolyte achieves improve flame retardancy, enhanced cycle life, and high decomposition voltage stability. Lithium secondary batteries using this electrolyte demonstrate robust capacity retention, superior durability under elevated temperatures, and stable performance during high-voltage operation.

### CROSS-REFERENCE TO RELATED APPLICATION

This present application claims under 35 U.S.C. § 119(a) the benefit of Korean Patent Application No. 10-2024-0166125, filed on Nov. 20, 2024, in the Korean Intellectual Property Office, the entire disclosure of which is incorporated herein by reference.

### FIELD

The present disclosure relates to an electrolyte composition for a lithium secondary battery and a lithium secondary battery comprising the same.

### BACKGROUND

In general, lithium secondary batteries have a higher operating voltage and a higher energy density than lead-acid batteries or nickel-cadmium batteries by accommodating electroactive materials. Accordingly, lithium secondary batteries are gaining attention as an energy storage means for electric vehicles (EVs) and hybrid electric vehicles (HEVs).

A lithium secondary battery is manufactured by placing a porous polymer separator between the negative electrode and the positive electrode and adding an electrolyte containing lithium salts such as LiPF₆. During charging, lithium ions are released from the positive electrode active material and inserted into the carbon layer of the negative electrode, and during discharging, lithium ions are released from the carbon layer and inserted into the positive electrode active material, with the electrolyte serving as a medium for lithium-ion movement between the negative electrode and the positive electrode

Existing carbonate-based electrolytes have low flash points and poor flame retardancy, resulting in reduced safety during short circuits and fires. To compensate for this, phosphorus (P)-based materials have been used as flame retardant solvents and additives, but battery life characteristics have deteriorated due to interface stability issues with the electrodes. Additionally, when using fluorine (F)-based materials as flame retardant solvents and additives, decreased salt solubility and ionic conductivity have occurred depending on the degree of fluorine substitution.

Accordingly, there is a need for research and development of flame-retardant electrolytes that simultaneously provide improved flame retardant characteristics and cell performance.

### SUMMARY

The present disclosure is directed to providing an electrolyte composition for a lithium secondary battery and a lithium secondary battery comprising same, capable of securing improved flame retardant characteristics while maintaining favorable cell performance such as cycle life characteristics, output characteristics, and oxidation stability.

Furthermore, the present disclosure is directed to providing an electrolyte composition for a lithium secondary battery that can be applied to green technology fields using batteries, such as electric vehicles.

Some embodiments of the present disclosure may provide an electrolyte composition for a lithium secondary battery, the electrolyte composition including a lithium salt, and a non-aqueous organic solvent, wherein the non-aqueous organic solvent includes a first carbonate-based solvent and a second carbonate-based solvent, and the second carbonate-based solvent includes a compound represented by Chemical Formula 1:

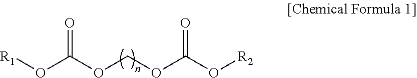

In Chemical Formula 1, R₁ and R₂ may each independently represent a C₂ to C₅ straight chain alkyl group substituted or unsubstituted with a halogen, and n may be an integer from 1 to 6.)

According to some embodiments, the compound represented by Chemical Formula 1 may be

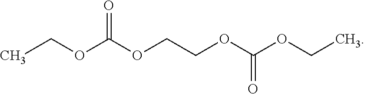

The first carbonate-based solvent according to some embodiments may comprise one or more selected from the group consisting of ethylene carbonate, propylene carbonate, butylene carbonate, vinylene carbonate, vinylethylene carbonate, fluoroethylene carbonate, ethylmethyl carbonate, dimethyl carbonate, diethyl carbonate, dipropyl carbonate, methylpropyl carbonate, methylisopropyl carbonate, and ethylpropyl carbonate.

Suitably, the first carbonate-based solvent and the second carbonate-based solvent are distinct (structurally different) chemical compositions. In some embodiments, the first carbonate-based solvent and the second carbonate-based solvent may be the same chemical compositions, although it is often preferred that that first carbonate-based solvent and the second carbonate-based solvent are distinct (structurally different) chemical compositions.

The lithium salt according to some embodiments may be one or more selected from the group consisting of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiCl, LiI, and LiB(C₂O₄)₂.

The non-aqueous organic solvent according to some embodiments may include the first carbonate-based solvent and the second carbonate-based solvent in a volume ratio of 1:0.5 to 1:1.2.

Some embodiments of the present disclosure may provide a lithium secondary including a positive electrode, a negative electrode, and the electrolyte composition for a lithium secondary battery.

The positive electrode according to some embodiments may include at least one transition metal comprising cobalt, manganese, and nickel, and a positive electrode active material comprising a lithium-nickel-cobalt-manganese composite oxide.

The lithium-nickel-cobalt-manganese composite oxide according to some embodiments may be Liₓ(NiₐCo_{b}Mn_{c})O₂ (0.5<x<1.3, 0<a<1, 0<b<1, 0<c<1, a+b+c=1), Liₓ(NiₐCo_{b}Mn_{c})O₄ (0.5<x<1.3, 0<a<2, 0<b<2, 0<c<2, a+b+c=2), or a mixture thereof.

The negative electrode according to some embodiments may include a carbon-based active material, a silicon-based active material, or a combination thereof.

The carbon-based active material according to some embodiments may include graphite, activated carbon, carbon nanotubes, carbon nanowires, graphene, carbon fibers, carbon black, or a combination thereof.

The silicon-based active material according to some embodiments may be at least one selected from Si, SiOₓ (0<x<2), metal-doped or carbon-coated SiOₓ (0<x<2), and a Si—C composite.

In some embodiments, an electrolyte composition for a lithium secondary battery, the electrolyte composition comprising: a lithium salt; and a non-aqueous organic solvent comprising a first carbonate-based solvent and a second carbonate-based solvent, wherein the second carbonate-based solvent comprises a compound represented by Chemical Formula 1:

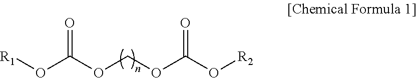

wherein R₁ and R₂ each independently represent a C2 to C5 straight chain alkyl group substituted or unsubstituted with a halogen, and n is an integer from 1 to 6, and wherein the compound represented by Chemical Formula 1 is present in an amount of about 20 volume % to about 60 volume % of the total volume of the non-aqueous organic solvent.

The compound represented by Chemical Formula 1 may be

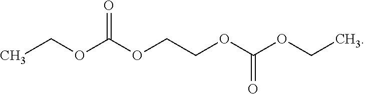

The lithium salt may include one of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiCl, LiI, LiB(C₂O₄)₂, or a combination of two or more.

The first carbonate-based solvent may include one of ethylene carbonate, propylene carbonate, butylene carbonate, vinylene carbonate, vinylethylene carbonate, fluoroethylene carbonate, ethylmethyl carbonate, dimethyl carbonate, diethyl carbonate, dipropyl carbonate, methylpropyl carbonate, methylisopropyl carbonate, ethylpropyl carbonate, or a combination of two or more.

The lithium salt may be present at a concentration of about 1.0M in the non-aqueous organic solvent.

The first carbonate-based solvent and the second carbonate-based solvent may be present in a volume ratio of about 1:0.5 to 1:1.2.

The first carbonate-based solvent may include ethylene carbonate and ethylmethyl carbonate in a volume ratio ranging from about 1:1 to about 3:2.

The non-aqueous organic solvent may include about 30 volume % of ethylene carbonate, about 20 volume % of ethylmethyl carbonate, and about 50 volume % of diethyl 2,5-dioxahexanedioate (DEDH), based on the total volume of the non-aqueous organic solvent.

The non-aqueous organic solvent may include about 30 volume % of ethylene carbonate, about 30 volume % of ethylmethyl carbonate, and about 40 volume % of diethyl 2,5-dioxahexanedioate (DEDH), based on the total volume of the non-aqueous organic solvent.

According to some embodiments of the present disclosure, an electrolyte with improved flame retardancy may be provided.

According to Some embodiments of the present disclosure, a lithium secondary battery with improved cycle life characteristics may be provided.

According to Some embodiments of the present disclosure, a lithium secondary battery with improved output characteristics may be provided.

According to Some embodiments of the present disclosure, a lithium secondary battery with improved oxidation stability at high potential may be provided.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is an experimental result confirming flame retardant characteristics of an electrolyte composition according to examples of the present disclosure and comparative examples.

FIG. 2 is a result of evaluating output performance of a lithium secondary battery comprising an electrolyte composition according to examples of the present disclosure and a comparative example.

FIG. 3 is a result of evaluating durability performance of a lithium secondary battery comprising an electrolyte composition according to examples of the present disclosure and a comparative example.

FIG. 4 is a result of linear sweep voltammetry analysis performed to measure the decomposition voltage of electrolyte compositions according to examples of the present disclosure and comparative examples.

### DETAILED DESCRIPTION

Hereinafter, the present disclosure will be described in more detail. However, the following embodiments are provided merely as references for describing the present disclosure in detail, and the present disclosure is not limited thereto and may be implemented in various forms

Unless otherwise defined, all technical and scientific terms used herein have the same meaning as commonly understood by those skilled in the art to which the present disclosure pertains.

The terms used herein are intended merely to describe particular embodiments effectively and are not intended to limit the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in the specification of the present disclosure, values outside the defined numerical ranges that may occur due to experimental error or rounding off of values are also included within the defined numerical ranges.

As used herein, the term “substituted” as used in this specification means that all or part of the hydrogen atoms of the substituted part (e.g., alkyl group) are replaced with substituents, and “unsubstituted” means that none of the hydrogen atoms of the alkyl group are replaced with substituents.

The term “non-aqueous organic solvent” herein refers to an organic solvent or mixture of solvents substantially free of water, capable of dissolving a lithium salt, and suitable for use in an electrochemical cell. In aspects, preferably an electrolyte composition will be at substantially free of water, e.g. an electrolyte composition will contain less than 10, 9, 8, 7, 6, 5, 4, 3, 2, 1, 0.5 or 0.1 weight percent water based on total weight of the electrolyte composition.

The term “carbonate-based solvent” herein refers to an organic solvent containing a carbonate functional group.

The term “lithium secondary battery” herein refers to a rechargeable electrochemical cell or battery that uses lithium-containing materials for its electrodes and can be repeatedly charged and discharged while maintaining its capacity over multiple cycles.

The following provides a more detailed description of the present disclosure.

The present disclosure relates to an electrolyte composition for a lithium secondary battery containing a compound represented by Chemical Formula 1 and a lithium secondary battery comprising same. The compound represented by Chemical Formula 1 has a high flash point and low volatility, making the electrolyte composition containing the compound have improved flame retardant characteristics. Additionally, a lithium secondary battery containing the electrolyte composition may exhibit cell performance equal to or better than that of existing commercial electrolytes applied to lithium secondary batteries.

The present disclosure provides an electrolyte composition for a lithium secondary battery, the electrolyte composition comprising a lithium salt and a non-aqueous organic solvent, wherein the non-aqueous organic solvent comprises a first carbonate-based solvent and a second carbonate-based solvent, and the second carbonate-based solvent comprises a compound represented by the following Chemical Formula 1:

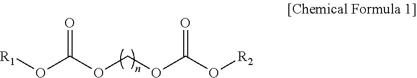

In Chemical Formula 1, R₁ and R₂ may independently be a C2 to C5 straight chain alkyl group, specifically a C2 to C3 straight chain alkyl group, more specifically a C2 alkyl group, substituted or unsubstituted with a halogen, and n may be an integer from 1 to 6, specifically an integer from 2 to 4, more specifically 2.

According to some embodiments, the halogen may be —F, —Cl, —Br, —I, specifically —F, —Cl, but is not limited thereto as long as it can achieve the objectives of the present disclosure.

According to an embodiment of the present disclosure, the lithium salt may comprise one of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiCl, LiI, LiB(C₂O₄)₂, or a combination of two or more, specifically LiPF₆, but is not limited thereto.

According to some embodiments, the first carbonate-based solvent may comprise one of ethylene carbonate, propylene carbonate, butylene carbonate, vinylene carbonate, vinylethylene carbonate, fluoroethylene carbonate, ethylmethyl carbonate, dimethyl carbonate, diethyl carbonate, dipropyl carbonate, methylpropyl carbonate, methylisopropyl carbonate, ethylpropyl carbonate, or a combination of two or more, specifically ethylene carbonate and ethylmethyl carbonate.

The compound represented by Chemical Formula 1 has a high flash point and low volatility, providing flame retardant characteristics to the electrolyte composition. In addition, it does not excessively increase the viscosity of the electrolyte composition, allowing cell performance equal to or better than existing commercial carbonate-based solvent-containing batteries.

According to some embodiments, the compound represented by Chemical Formula 1 may be Diethyl 2,5-Dioxahexanedioate, which can be represented by the following Structural Formula 1.

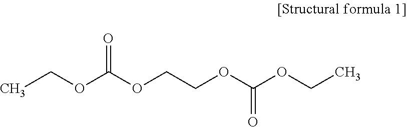

According to some embodiments, the non-aqueous organic solvent may comprise the first carbonate-based solvent and the second carbonate-based solvent in a volume ratio of 1:0.5 to 1:1.2, specifically 1:0.6 to 1:1. When satisfying this range, the increase in viscosity of the electrolyte composition due to the second carbonate-based solvent comprising the compound represented by Chemical Formula 1, and the resulting deterioration of cell performance, may be suppressed.

In addition, the present disclosure provides a lithium secondary battery comprising a positive electrode, a negative electrode, and the above-described electrolyte composition for a lithium secondary battery.

The description of the electrolyte composition for a lithium secondary battery is the same as described above and is thus omitted here.

According to some embodiments, the positive electrode, may include at least one transition metal selected from cobalt, manganese, nickel, or a combination of two or more thereof and a positive electrode active material which is a lithium-nickel-cobalt-manganese composite oxide. An unshared electron pair contained in the compound represented by Chemical Formula 1 may coordinate with the transition metals of the positive electrode to stabilize the positive electrode structure, suppressing side reactions on the positive electrode surface during high-temperature storage, thus improving the high-temperature storage stability of the lithium secondary battery.

According to some embodiments, the lithium-nickel-cobalt-manganese composite oxide may be Liₓ(NiₐCo_{b}Mn_{c})O₂(0.5<x<1.3, 0<a<1, 0<b<1, 0<c<1, a+b+c=1), Liₓ(NiₐCo_{b}Mn_{c})O₄(0.5<x<1.3, 0<a<2, 0<b<2, 0<c<2, a+b+c=2), or a mixture thereof, specifically Liₓ(NiₐCo_{b}Mn_{c})O₂ where 0.90≤x≤1.10, 0.3≤a≤0.8, 0.1≤b≤0.5, 0.1≤c<0.5, and a+b+c=1.

According to some embodiments, the negative electrode may comprise a carbon-based active material, a silicon-based active material, or a combination thereof.

According to some embodiments, the carbon-based active material may comprise graphite, activated carbon, carbon nanotubes, carbon nanowires, graphene, carbon fibers, carbon black, or a combination thereof, specifically graphite. According to some embodiments, the silicon-based active material may comprise one of Si, SiOₓ (0<x<2), metal-doped or carbon-coated SiOₓ (0<x<2), a Si—C composite, or a combination of two or more. Accordingly, the negative electrode may comprise graphite and a Si—C composite or may comprise SiOₓ (0<x<2).

According to some embodiments, the lithium secondary battery may further comprise a separator interposed between the negative electrode and the positive electrode.

The separator material is not particularly limited in the present disclosure and may be selected from materials known in the art. Some detailed examples are as below.

In some embodiments of the present disclosure, the separator may be a separator having micropores through which ions can pass, and as non-limiting examples, may be a combination of one or more selected from the group consisting of glass fiber, polyester, polyethylene, polypropylene, and polytetrafluoroethylene, and may be in the form of a non-woven fabric or woven fabric. Specifically, the lithium secondary battery may primarily use polyolefin-based polymer separators such as polyethylene and polypropylene, but the present disclosure is not limited thereto. In addition, to enhance heat resistance or mechanical strength, a separator coated with a composition comprising ceramic components or polymer materials may also be used, the separator may optionally have a single-layer or multi-layer structure, and a separator known in the art may be used, but the present disclosure is not limited thereto.

In some embodiments of the present disclosure, the external shape of the lithium secondary battery is not particularly limited, but may be selected from, for example a cylindrical shape using a can, a square shape, a pouch shape, or a coin shape.

Hereinafter, various examples of the present disclosure and comparative examples will be described. However, the following examples are merely various examples of the present disclosure, and the present disclosure is not intended to be limited thereto.

### Example 1

An electrolyte composition for a lithium secondary battery was obtained by mixing a non-aqueous organic solvent and a lithium salt. The non-aqueous organic solvent comprised 30 volume % of ethylene carbonate (EC), 20 volume % of ethylmethyl carbonate (EMC), and 50 volume % of diethyl 2,5-Dioxahexanedioate (DEDH) of the total solvent volume, and the lithium salt was LiPF₆ with a concentration of 1.0M.

A positive electrode slurry was prepared by mixing LiNi_{0.8}Co_{0.1}Mn_{0.1}O₂ as a positive electrode active material, polyvinylidene fluoride (PVdF) as a binder, and carbon as a conductive agent in a weight ratio of 98:1:1 and dispersing them in N-methyl-2-pyrrolidone. This slurry was coated on an aluminum foil with a thickness of 20 m, then dried and rolled to manufacture a positive electrode.

A negative electrode slurry was prepared by mixing graphite/Si—C composite as a negative electrode active material, styrene-butadiene rubber (SBR) as a binder, and carboxymethylcellulose (CMC) as a thickener in a weight ratio of 97:1:2 and dispersing them in water. This slurry was coated on a copper foil with a thickness of 15 m, then dried and rolled to manufacture a negative electrode.

A polyethylene (PE) film separator with a thickness of 25 m was stacked between the electrodes to form a pouch cell with a size of 6 mm thickness×60 mm width×90 mm length, and the electrolyte composition for a lithium secondary battery was injected to manufacture a lithium secondary battery.

### Example 2

A lithium secondary battery was manufactured in the same manner as Example 1, except that the non-aqueous organic solvent comprised 30 volume % of ethylene carbonate (EC), 30 volume % of ethylmethyl carbonate (EMC), and 40 volume % of diethyl 2,5-Dioxahexanedioate (DEDH) of the total solvent volume.

### Comparative Example 1

A lithium secondary battery was manufactured in the same manner as Example 1, except that the non-aqueous organic solvent comprised 30 volume % of ethylene carbonate (EC) and 70 volume % of ethylmethyl carbonate (EMC) of the total solvent volume.

### Comparative Example 2

A lithium secondary battery was manufactured in the same manner as Example 1, except that the non-aqueous organic solvent comprised 30 volume % of ethylene carbonate (EC) and 70 volume % of diethyl 2,5-Dioxahexanedioate (DEDH) of the total solvent volume.

### Comparative Example 3

A lithium secondary battery was manufactured in the same manner as Example 1, except that the non-aqueous organic solvent comprised 30 volume % of ethylene carbonate (EC), 10 volume % of ethylmethyl carbonate (EMC), and 60 volume % of diethyl 2,5-Dioxahexanedioate (DEDH) of the total solvent volume.

### Comparative Example 4

A lithium secondary battery was manufactured in the same manner as Example 1, except that the non-aqueous organic solvent comprised 30 volume % of ethylene carbonate (EC), 40 volume % of ethylmethyl carbonate (EMC), and 30 volume % of diethyl 2,5-Dioxahexanedioate (DEDH) of the total solvent volume.

### Experimental Example 1: Flame Retardancy Evaluation

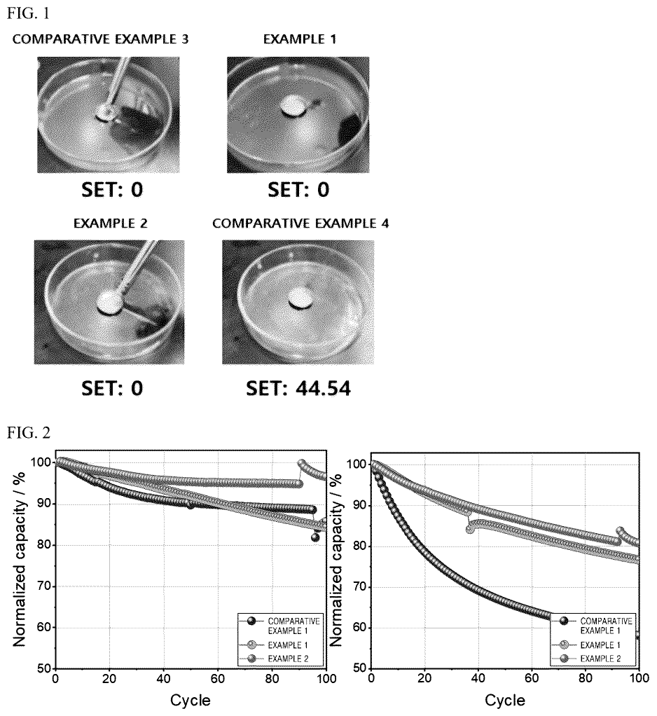

To evaluate flame retardancy, the electrolyte compositions of Examples 1 and 2 and Comparative Examples 3 and 4 were placed in a case with an air contact surface, and the self-extinguishing time (SET) was measured, with the results shown in FIG. 1. SET represents the time from ignition to extinction of the electrolyte and considering that the combustion time varies depending on the weight of the electrolyte, the present disclosure introduced combustion time per weight (unit: sec/g).

As shown in FIG. 1, the electrolyte composition of Comparative Example 4 showed a SET of 44.54 sec/g, indicating that flame retardancy was not secured. In contrast, the remaining electrolyte compositions did not ignite, confirming that improved flame retardancy can be secured when the non-aqueous organic solvent contains DEDH in amounts of 40 volume % or more of the total solvent volume.

### Experimental Example 2: Output Performance Evaluation

To examine the output performance characteristics at room temperature according to the amount of the second carbonate-based solvent added to the electrolyte composition, the output performance of lithium secondary batteries of the examples and comparative examples was measured at room temperature (25° C.), and the results are shown in Table 1 and FIG. 2.

The experiment was conducted with the following conditions: Cut-off: 2.5-4.2V, C-rate: 0.5C charging/5.0C discharging, and temperature: 25° C.

TABLE 1

| | Non-aqueous organic | | | Output performance @ |
|---|---|---|---|---|
| | solvent (vol %) | | | 0.5 C vs. xC (%) |
| | EC | EMC | DEDH | @5 C |
| Comparative | 30 | 70 | — | 87.5 |
| Example 1 | | | | |
| Comparative | 30 | — | 70 | 64.4 |
| Example 2 | | | | |
| Comparative | 30 | 10 | 60 | 57.2 |
| Example 3 | | | | |
| Example 1 | 30 | 20 | 50 | 81.9 |
| Example 2 | 30 | 30 | 40 | 83.3 |

As can be seen in FIG. 2 and Table 1, Examples 1 and 2, which contain DEDH at 50 volume % and 40 volume % of the total non-aqueous organic solvent volume, respectively, showed output performance equivalent to that of Comparative Example 1, which uses existing commercial carbonate solvents. Meanwhile, Comparative Examples 2 and 3, which contain 60 volume % or more of DEDH, showed significantly decreased output performance due to reduced ionic conductivity resulting from increased viscosity of the electrolyte composition.

### Experimental Example 3: Durability Performance Evaluation

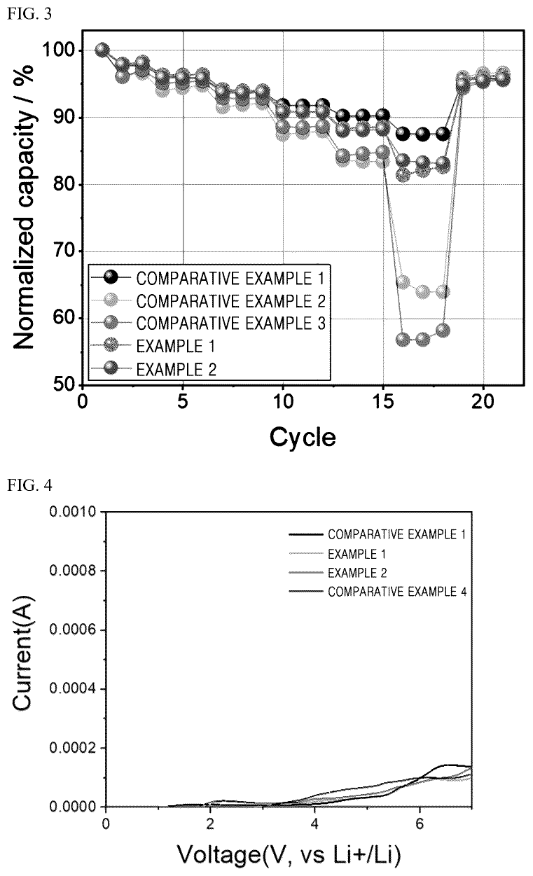

To examine the capacity retention characteristics according to the amount of the second carbonate-based solvent added to the electrolyte composition, capacity retention after 100 cycles was measured at room temperature (25° C.) and high temperature (45° C.), and the results are shown in Table 2 and FIG. 3. Meanwhile, Comparative Examples 2 and 3 were excluded from the evaluation due to inferior output characteristics.

The experiment was conducted by charging each manufactured lithium secondary battery at room temperature (25° C.) and high temperature (45° C.) with a current of 0.1C rate until the voltage reached 4.2V (vs. Li), then continuing with constant voltage charging at 4.2V until cut-off at a current of 0.02C rate. The battery was discharged with a constant current of 0.1C rate until the voltage reached 2.5V (vs. Li). This charging and discharging constituted 1 cycle, and after one more identical cycle, the applied current for charging and discharging was changed to 0.5C and continued for 100 cycles, with a 10-minute rest period between cycles. The capacity retention ratio was calculated as defined by the following Equation 1:

$$Capacity retention ratio ( \% ) = [ Discharge capacity at 100 th cycle / Discharge capacity at 1 st cycle ] \times 100 \qquad [ Equation 1 ]$$

TABLE 2

| | | | | Cycle life capacity retention (%) | |
|---|---|---|---|---|---|
| | | | | @100 cyc | |
| | Non-aqueous organic | | | Room | High |
| | solvent (vol %) | | | temperature | temperature |
| | EC | EMC | DEDH | durability | durability |
| Comparative | 30 | 70 | — | 85.7 | 58.1 |
| Example 1 | | | | | |
| Example 1 | 30 | 20 | 50 | 84.3 | 76.6 |
| Example 2 | 30 | 30 | 40 | 96.5 | 80.7 |

As can be seen in FIG. 3 and Table 2, Examples 1 and 2, which contain DEDH at 50 volume % and 40 volume % of the total non-aqueous organic solvent volume, respectively, showed durability performance at room temperature and high temperature equal to or better than that of Comparative Example 1, which uses existing commercial carbonate solvents.

### Experimental Example 4: Linear Sweep Voltammetry (LSV) Analysis

To measure the decomposition voltage of the electrolyte compositions according to the examples and comparative examples through linear sweep voltammetry analysis, the experiment was conducted as follows. Specifically, a SUS electrode was used as the working electrode, lithium metal was used as the reference electrode and counter electrode, and measurements were taken in the voltage range of 3 V to 7 V with a scan rate of 0.1 mV/s. Multi-Channel Potentiostat (Ametek Co.) PMC-100 was used as the LSV measurement device. The results are shown in FIG. 4 and Table 3.

TABLE 3

| | Non-aqueous organic | | | |
|---|---|---|---|---|
| | solvent (vol %) | | | Decomposition |
| | EC | EMC | DEDH | voltage (V) |
| Comparative | 30 | 70 | — | 5.35 |
| Example 1 | | | | |
| Example 1 | 30 | 20 | 50 | 5.37 |
| Example 2 | 30 | 30 | 40 | 5.44 |
| Comparative | 30 | 40 | 30 | 5.19 |
| Example 4 | | | | |

As can be confirmed through FIG. 4 and Table 3, the electrolyte compositions manufactured in Examples 1 and 2 decompose later than the commercial electrolyte composition of Comparative Example 1. Accordingly, the electrolyte compositions according to the examples have improved oxidation stability and can increase the life of lithium secondary batteries.

The features, structures, effects, and the like described in the exemplary embodiments above are included in at least one embodiment of the present disclosure and are not necessarily limited to a single embodiment. Furthermore, the features, structures, effects, and the like exemplified in each exemplary embodiment can be combined or modified in other embodiments by those skilled in the art to which the embodiments pertain. Therefore, such combinations and modifications should be construed as being within the scope of the present disclosure.

What is claimed is:

1. An electrolyte composition for a lithium secondary battery, the electrolyte composition comprising:
a lithium salt; and
a non-aqueous organic solvent,
wherein the non-aqueous organic solvent comprises a first carbonate-based solvent and a second carbonate-based solvent,
wherein the second carbonate-based solvent comprises a compound represented by Chemical Formula 1: 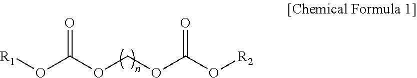
wherein R₁ and R₂ each independently represent a C2 to C5 straight chain alkyl group substituted or unsubstituted with a halogen, and n is an integer from 1 to 6.

2. The electrolyte composition for a lithium secondary battery according to claim 1, wherein the compound represented by Chemical Formula 1 is

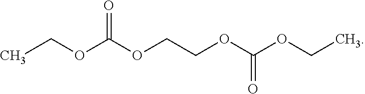

3. The electrolyte composition for a lithium secondary battery according to claim 1, wherein the first carbonate-based solvent comprises one of ethylene carbonate, propylene carbonate, butylene carbonate, vinylene carbonate, vinylethylene carbonate, fluoroethylene carbonate, ethylmethyl carbonate, dimethyl carbonate, diethyl carbonate, dipropyl carbonate, methylpropyl carbonate, methylisopropyl carbonate, ethylpropyl carbonate, or a combination of two or more.

4. The electrolyte composition for a lithium secondary battery according to claim 1, wherein the lithium salt comprises one of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiCl, LiI, LiB(C₂O₄)₂, or a combination of two or more.

5. The electrolyte composition for a lithium secondary battery according to claim 1, wherein the first carbonate-based solvent and the second carbonate-based solvent are present in a volume ratio of about 1:0.5 to 1:1.2.

6. A lithium secondary battery comprising:
a positive electrode;
a negative electrode; and
the electrolyte composition according to claim 1.

7. The lithium secondary battery according to claim 6, wherein the positive electrode comprises:
at least one transition metal comprising cobalt, manganese, nickel, or a combination of two or more thereof, and
a positive electrode active material comprising a lithium-nickel-cobalt-manganese composite oxide.

8. The lithium secondary battery according to claim 7, wherein the lithium-nickel-cobalt-manganese composite oxide is Liₓ(NiₐCo_{b}Mn_{c})O₂ (0.5<x<1.3, 0<a<1, 0<b<1, 0<c<1, a+b+c=1), Liₓ(NiₐCo_{b}Mn_{c})O₄ (0.5<x<1.3, 0<a<2, 0<b<2, 0<c<2, a+b+c=2), or a mixture thereof.

9. The lithium secondary battery according to claim 6, wherein the negative electrode comprises a carbon-based active material, a silicon-based active material, or a combination thereof.

10. The lithium secondary battery according to claim 9, wherein the carbon-based active material comprises graphite, activated carbon, carbon nanotubes, carbon nanowires, graphene, carbon fibers, carbon black, or a combination thereof.

11. The lithium secondary battery according to claim 9, wherein the silicon-based active material comprises one of Si, SiOₓ (0<x<2), metal-doped or carbon-coated SiOₓ (0<x<2), a Si—C composite, or a combination of two or more.

12. An electrolyte composition for a lithium secondary battery, the electrolyte composition comprising:
a lithium salt; and
a non-aqueous organic solvent comprising a first carbonate-based solvent and a second carbonate-based solvent,
wherein the second carbonate-based solvent comprises a compound represented by Chemical Formula 1: 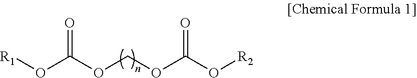
wherein R₁ and R₂ each independently represent a C2 to C5 straight chain alkyl group substituted or unsubstituted with a halogen, and n is an integer from 1 to 6. And
wherein the compound represented by Chemical Formula 1 is present in an amount of about 20 volume % to about 60 volume % of the total volume of the non-aqueous organic solvent.

13. The electrolyte composition for a lithium secondary battery according to claim 12, wherein the compound represented by Chemical Formula 1 is

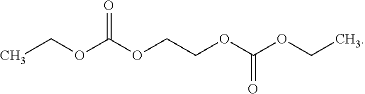

14. The electrolyte composition for a lithium secondary battery according to claim 12, wherein the lithium salt comprises one of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiCl, LiI, LiB(C₂O₄)₂, or a combination of two or more.

15. The electrolyte composition for a lithium secondary battery according to claim 12, wherein the first carbonate-based solvent comprises one of ethylene carbonate, propylene carbonate, butylene carbonate, vinylene carbonate, vinylethylene carbonate, fluoroethylene carbonate, ethylmethyl carbonate, dimethyl carbonate, diethyl carbonate, dipropyl carbonate, methylpropyl carbonate, methylisopropyl carbonate, ethylpropyl carbonate, or a combination of two or more.

16. The electrolyte composition for a lithium secondary battery according to claim 12, wherein the lithium salt is present at a concentration of about 1.0M in the non-aqueous organic solvent.

17. The electrolyte composition for a lithium secondary battery according to claim 12, wherein the first carbonate-based solvent and the second carbonate-based solvent are present in a volume ratio of about 1:0.5 to 1:1.2.

18. The electrolyte composition of claim 12, wherein the first carbonate-based solvent comprises ethylene carbonate and ethylmethyl carbonate in a volume ratio ranging from about 1:1 to about 3:2.

19. The electrolyte composition of claim 12, wherein the non-aqueous organic solvent comprises about 30 volume % of ethylene carbonate, about 20 volume % of ethylmethyl carbonate, and about 50 volume % of diethyl 2,5-dioxahexanedioate (DEDH), based on the total volume of the non-aqueous organic solvent.

20. The electrolyte composition of claim 12, wherein the non-aqueous organic solvent comprises about 30 volume % of ethylene carbonate, about 30 volume % of ethylmethyl carbonate, and about 40 volume % of diethyl 2,5-dioxahexanedioate (DEDH), based on the total volume of the non-aqueous organic solvent.
